(19) United States
(12) Patent Application Publication
(10) Pub. No.: US 2020/0085165 A1
(43) Pub. Date: Mar. 19, 2020

(54) MANICURE KIT AND METHOD THEREOF

(71) Applicant: Renate Beth Jones, Port St. Lucie, FL (US)

(72) Inventor: Renate Beth Jones, Port St. Lucie, FL (US)

(21) Appl. No.: 16/131,019

(22) Filed: Sep. 13, 2018

(51) Int. Cl. A45D 29/18; A45D 29/00; B05D 1/38

(52) U.S. Cl. CPC A45D 29/18; A45D 29/004; A45D 2031/005; A45D 2029/002; B05D 1/38

(57) ABSTRACT

A manicure nail kit and a method of applying and manufacturing the nail kit, the manicure nail kit including at least a nail paint with a solid nail tip color and a nail bed color formed from a diluted version of the nail tip color with a clear coat.

### FIELD OF THE INVENTION

The present invention relates to a manicure kit and a method of applying the manicure kit, and more particularly to a manicure kit that has the appearance of a sold color tip portion that transitions into diluted base color.

### BACKGROUND OF THE INVENTION

French manicure kits commonly provide a white tip color nail polish and a nude or clear nail bed color. In addition, many French manicure kits include a clear base and/or top coat to provide chip protection.

However, there is a need in the art for alternative manicure kits with alternative nail kit colors and styles, including a variation of the well-known French manicure.

### SUMMARY OF THE INVENTION

The present invention advantageously provides a manicure kit and method of applying the nail polish, in which the nail bed is colored with a diluted version of the nail tip color.

According to an embodiment of the present invention, a principal object is to provide a manicure kit that is easily applied by consumers within the need to seek a professional nail technician.

According to these and other objects of an embodiment of the present invention are accomplished by a solid tip color combined with a nail bed color formed from a diluted solid tip color.

According to an embodiment of the present invention, another object is to provide a manicure kit includes decorations that combine with the solid tip color and the diluted nail bed color.

According to an embodiment of the present invention, another object is to provide a manicure kit that is simple to manufacture by admixing a solid nail bed color with a clear coat to create a diluted nail bed color.

Yet another object of one embodiment of the present invention is to provide a clear coat for applying a base coat and/or over both the solid tip color and the diluted nail bed color.

Yet another object of one embodiment of the present invention is to provide a manicure boxed kit with one or more solid tip colors, one or more diluted nail bed color from which each of the one or more diluted nail bed colors are formed from a matching solid tip color, and a clear coat.

Yet another object of one embodiment of the present invention is to provide a manicure kit comprising at least 10 artificial nails with an adhesive, the at least 10 artificial nails provided with a painted solid tip color and a nail bed painted with a diluted tip color. The artificial nails may be applied to a person's nail with adhesive.

Yet another object of one embodiment of the present invention is to provide a Spanish manicure kit defined as a colored tip nail paint and a diluted nail bed color formed of the tip nail paint diluted with a clear coat paint.

Yet another object of one embodiment of the present invention is to provide a manicure kit that includes a box containing a first bottle nail paint containing a solid tip color, a second bottle of nail paint formed from said solid tip color and a dilution substance to create a diluted nail bed color of said first bottle nail paint, a third bottle of nail paint containing a clear coat.

Yet another object of one embodiment is to provide a dilution substance that is the same clear coat found within the third bottle of nail paint found with the manicure kit.

Yet another object of one embodiment on the present invention is to provide one bottle of diluted nail paint that is mixed from a tip color found in the manicure kit and a clear coat found in the manicure kit.

One embodiment of the present invention includes a method of applying a nail style that includes applying a nail bed color to at least one nail, applying a tip color over a portion of the nail bed color to at least one nail, and wherein the nail bed color is formed of a diluted nail bed color.

One embodiment of the present invention includes a method of manufacturing a nail kit that includes packaging a solid tip color in a first bottle, diluting a nail tip color to form a diluted nail bed color paint, packaging the diluted nail bed color in a second bottle, packaging a clear base and/or top coat in a third bottle, and packaging the first, second, and third bottle in a box.

One embodiment of the present invention includes a method of applying a nail style that includes applying a base coat of clear paint to at least one nail, applying a paint guide to the at least one nail, applying a tip color over a portion of the nail tip, removing the paint guide after the tip color has dried onto the nail tip, applying a nail bed color to the entire nail, wherein the nail bed color is formed of a diluted tip color.

Other objects will become evident as the present invention is described in detail below.

### BRIEF DESCRIPTION OF THE DRAWINGS

Embodiments of the present application are described herein in which similar elements are given similar reference characters, and a more complete understanding of the present invention, and the attendant advantages and features thereof, will be more readily understood by reference to the following detailed description when considered in conjunction with the accompanying drawings wherein:

FIG. 1 is a perspective view of a manicure kit in accordance with the features of one embodiment of the present invention;

FIG. 2 is a top perspective view of nails in accordance with the features of one embodiment of the present invention;

FIG. 3 is a front view of a sheet of nail guides in accordance with the features of one embodiment of the present invention; and

FIG. 4 is a block diagram of a method of applying the manicure kid in accordance with the features of one embodiment of the present invention.

### DETAILED DESCRIPTION OF THE INVENTION

The present invention advantageously provides a manicure kit and method of application and manufacture thereof. The present invention contemplates various types of manicure kits in accordance with various embodiments of the invention.

Accordingly, the manicure kit has been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

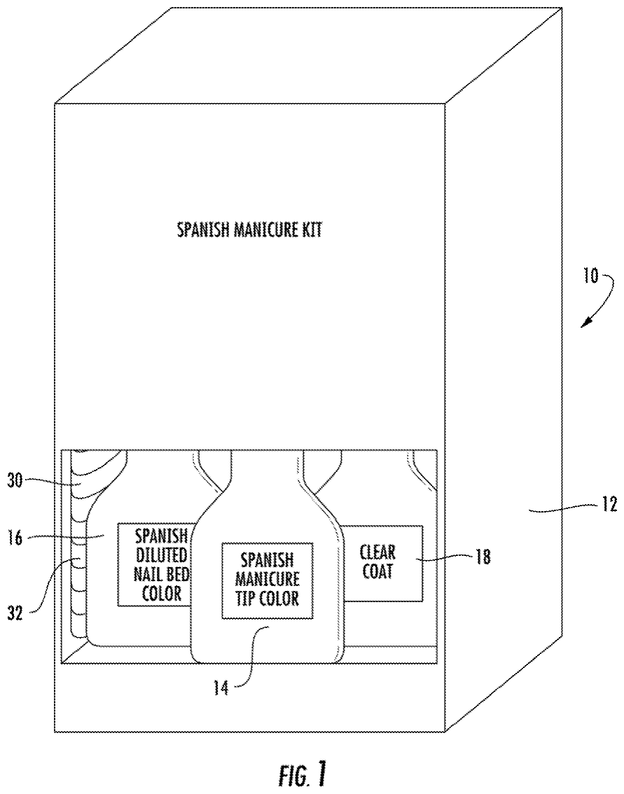

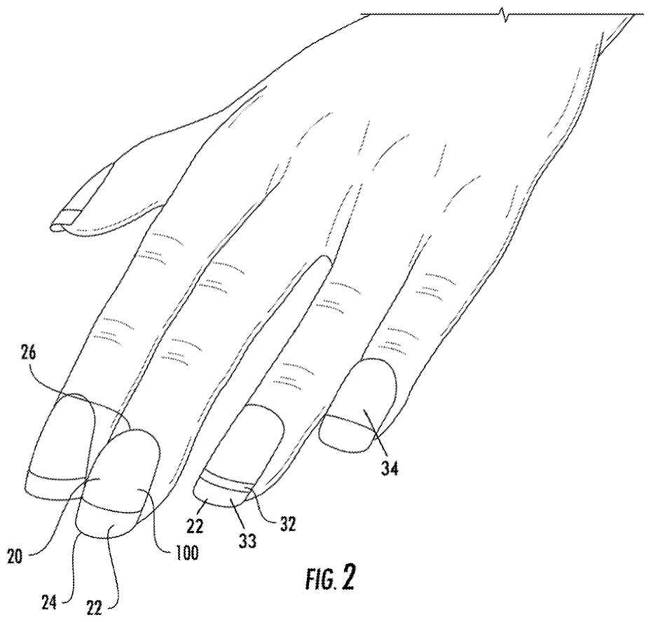

Referring now to the drawing figures in which like reference designators refer to like elements. FIG. 1 shows an exemplary manicure kit constructed in accordance with the principles of the present invention and designated generally as manicure kit 10. In particular, the manicure kit 10 includes a box 12 or other packaging. The box 12 includes at least a first bottle 14 that contains a solid manicure tip color 22 (FIG. 2) and a second bottle 16 that contains a diluted nail bed color 20 (FIG. 2) of diluted nail bed color. The second bottle 16 of diluted nail bed color 20 is formed at least of a combination of the solid manicure tip color 22 and a clear coat solution defining the diluted nail bed color 20. The manicure kit 10 optionally further includes a third bottle 18 of clear or opaque base and/or top coat substance 34 (FIG. 2).

The third bottle 18 of clear or opaque base and/or top coat substance is applied to the nails 100 of a person for preventing chipping or discoloration of the overlying and/or underlying tip color and diluted nail bed color.

For exemplary purposes, when the solid manicure tip color is green, the nail bed color will be a diluted version from the same color green to form a lightened green. It is within the spirit and scope of the present invention that any conceivable color may be used to create the tip color and nail bed color from a diluted version of the tip color, including the colors red, blue, purple, green, pink, and the like.

Referring now to FIGS. 1 and 2, in operation, the second bottle 16 in FIG. 1 contains a tip color that has been diluted to form a diluted nail bed color 20 that is applied to the entire nail 100 of a person's nails shown in FIG. 2 from a proximal end 26 of the nail to a distal tip 24 of the nail of the person.

In one non-limiting embodiment, the nail bed color 20 may only be applied to a portion of the nail, such as just the nail bed.

In one non-limiting embodiment shown in FIG. 2, the solid manicure tip color 22 may only be applied to a portion of the nail(s), namely just the tip of the nail(s).

In one exemplary application process, after the diluted nail bed color 20 is dry on the nail of the person, the first bottle 14 of solid manicure tip color 22 is applied to the distal tip 24 of the nail of the person. In one non-limiting embodiment, after the solid manicure tip color 22 is dry on the nail of the person, a clear base and/or top coat 28 is applied from the third bottle 18.

Referring to FIG. 1, the manicure kit 10 further optionally includes a sheet 30 of paint guides 32. Each paint guide 32 includes an adhesive substance such that the paint guide temporarily adheres to the user's nails 100. In one non-limiting embodiment shown in FIG. 2, the paint guide 32 are affixed to the user's nail(s) just below the nail tip of the nail 100 for applying tip color 22 and/or just above the nail bed of the nail 100 when applying the diluted nail bed color 20.

In operation, shown in FIG. 2, when the paint guide 32 is affixed below the nail tip, the solid manicure tip color 22 is applied above the convex shape of the paint guide 32. In yet another operation, when the paint guide is affixed just above the nail bed of the nail 100, the diluted nail bed color 20 is applied below the concave shape of the paint guide 32.

The paint guide 32 is affixed to the user's nails either before paint is applied to the nails or after any existing paint has dried. Additionally, after the paint guide 32 is adhered to the nail 100 of a user, the paint guide 32 is left on the nail 100 until any nail paint and/or nail polish applied after affixing the paint guide 32 to the nail dries.

Referring to FIG. 2, nail guide 32 is shown for exemplary purposes affixed to the ring finger just below the tip of the nail 100 for applying the solid tip color 22.

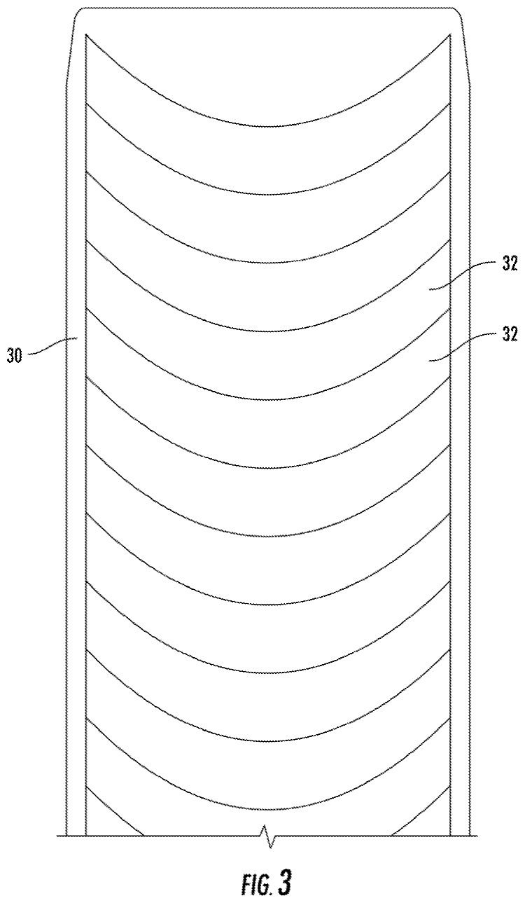

Referring now to FIG. 3, sheet 30 includes paint guides 32 that are provided in a vertical alignment. The paint guides 32 are peeled or otherwise removed from the sheet 30 for applying to the nails 100 of a user for guiding paint application in the manicure kit 10. The paint guides 32 will create sharp paint lines on the nails 100 in the transition from the solid manicure tip color 22 and the diluted nail bed color 20.

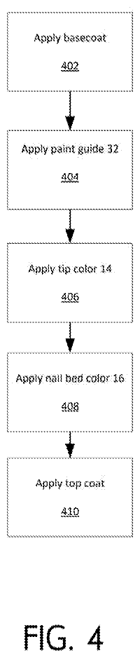

Referring now to FIG. 4, at block 402, the user is instructed to apply a base coat contained within the third bottle using the clear paint that may prevent chipping and/or discoloration of the user's nails. A user applies the base coat using clear paint from the third bottle 18.

At block 404, prior to applying either of the first bottle 14 containing solid manicure tip color 22 nail polish or the second bottle 16 containing nail bed color 20, the user is instructed to apply a paint guide 32 to the nails 100 of the user below the nail tip 33 (See FIG. 3). The user applies the paint guide 32 below the nail tip.

At block 406, the user is instructed to apply the first bottle 14 of solid manicure tip color 22 to the nails 100. The user applies the solid manicure tip color 22 nail polish to the nail tip 33 above the paint guide 32 that is adhered to the nail 100. In a non-limiting embodiment, the user leaves the paint guide 32 on the nail until the solid manicure tip color 22 nail polish has dried. The user then removes the paint guide 32 after the solid manicure tip color 22 has dried.

At block 408, the user is instructed to apply the diluted nail bed color 20 to the nails 100 of the user. The user applies the diluted nail bed color 20 to the entire nail from the distal tip 24 to the proximal end 26. The diluted nail bed color 20 is applied over the solid manicure tip color 22.

At block 410, the user is instructed to apply top coat of clear paint to the nails 100. The user applies the top coat of paint to the nail between the entire length of the nail between the proximal end 26 to the distal tip 24. The top coat provides a clear protection for the applied nail polish.

It will be appreciated to those persons skilled in the art that the invention can be applied to a persons nail and/or to artificial nails such as acrylic nails.

It is within the spirit and scope of the invention that the clear coat may optionally be a color or sheer or other desired nail paint.

As used herein, when the term “and/or” is used, it shall include all combinations of one or more of the associated described items.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are contemplated in light of the above teachings without departing from the scope and spirit of the invention. It will be readily apparent that various changes may be made thereto without departing from the spirit and scope of the disclosure or sacrificing all of its material advantages. The examples and embodiments described herein are merely exemplary of the instant disclosure.

What is claimed is:

1. A manicure kit comprising:
a box containing:
a first bottle nail paint containing a solid tip color;
a second bottle of nail paint formed from said solid tip color and a dilution substance to create a diluted nail bed color of said first bottle nail paint; and
a third bottle of nail paint containing a clear coat.

2. The manicure kit of claim 1 wherein said dilution substance is the same clear coat found within the third bottle of nail paint.

3. A method of applying a nail style comprising:
applying a base coat of clear paint to at least one nail;
applying a paint guide to the at least one nail;
applying a tip color over a portion of a nail tip;
removing the paint guide after the tip color has dried onto the nail tip;
applying a nail bed color to the entire at least one nail;
wherein said nail bed color is formed of a diluted tip color.

4. A method of manufacturing a nail kit comprising:
packaging a solid tip color in a first bottle;
diluting a nail tip color to form a diluted nail bed color paint;
packaging the diluted nail bed color in a second bottle;
packaging a clear top coat in a third bottle; and
packaging the first, second, and third bottle in a box.
